(19) United States
(12) Patent Application Publication
(10) Pub. No.: US 2003/0000863 A1
(43) Pub. Date: Jan. 2, 2003

(54) Replaceable decoration plate for boxes

(76) Inventor: Daniel Lee, Tali City (TW)

Correspondence Address: CHARLES E. BAXLEY, ESQUIRE, Hart, Baxley, Daniels & Holton, 59 John St, 5 FI, New York, NY, 10038, US

(21) Appl. No.: 09/892,624

(22) Filed: Jun. 28, 2001

(51) Int. Cl. B65D 85/00; G09F 3/00

(52) U.S. Cl. 206/459.5; 40/312

(57) ABSTRACT

A box includes a first part and a second part which is pivotally connected to the first part. A plurality of apertures are defined through the second part and a decoration plate is engaged with an inside of the second part. The decoration plate has a plurality of protrusions extending from the decoration plate and the protrusions are engaged with the apertures.

### FIELD OF THE INVENTION

The present invention relates to a box having an aperture defined through a wall thereof and a decoration plate having a protrusion which is engaged with the aperture.

### BACKGROUND OF THE INVENTION

A conventional tool box is shown in FIG. 1 and generally includes a base 100 and a cover 11 which is pivotally connected to the base 100. A decoration portion 10 is formed on the outside of the cover 11 so as to be seen by people. The decoration portion 10 often is used to illustrate trademarks or special meaning for the tool box. In order to obtain a good looking of the tool box, the decoration portion 10 can be a sticker which is conveniently adhered on the cover 11. The sticker may be made to have different version and colors so that it can be changed accordingly practical needs such as the color of the cover 11. However, the patterns on the sticker are easily to be worn off and this is concerned by the users or the manufacturers. The other way to obtain the decoration portion 10 is to make the patterns of the decoration portion 10 and the cover 11 to be a one-piece member by using special plastic mold injection techniques. The techniques allows to inject two different colors of material into a mold so as to have the cover 11 involving two different colors. This costs too much and cannot meet commercial purposes.

### SUMMARY OF THE INVENTION

In accordance with one aspect of the present invention, there is provided a box that comprises a first part and a second part which is pivotally connected to the first part. A plurality of apertures are defined through the second part and a decoration plate is engaged with an inside of the second part. A plurality of protrusions extend from the decoration plate and engaged with the apertures.

The primary object of the present invention is to provide a box that has a replaceable decoration plate which has protrusions extend through apertures in the box.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional sticker adhered on a box;

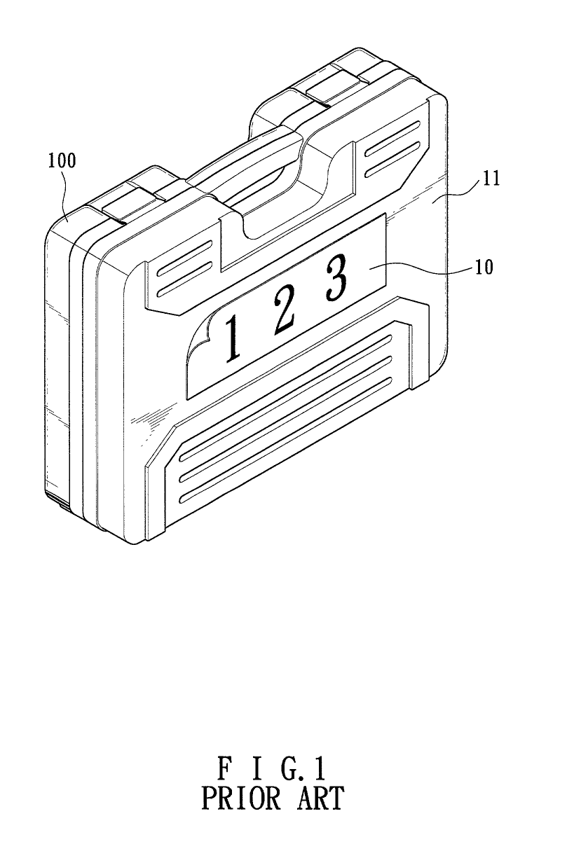

FIG. 2 is an exploded view to show a decoration plate and a box of the present invention;

FIG. 3 is a perspective view to show the box with the decoration plate engaged with the cover of the box, and

FIG. 4 is a cross sectional view to show the protrusions of the decoration plate are engaged with the apertures in the cover.

### DETAILED DESCRIPTION OF THE PREFERRED EMBODIMENT

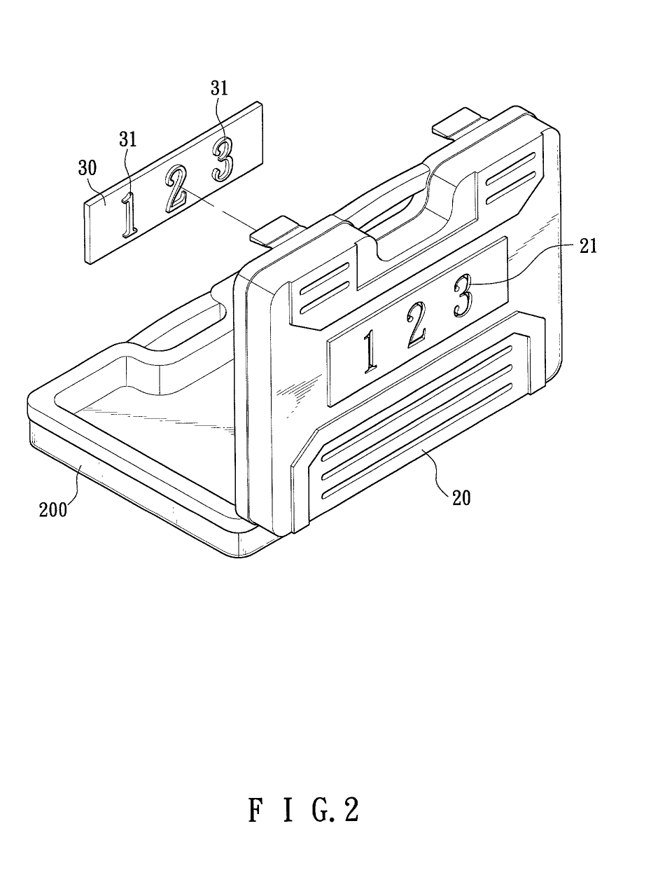

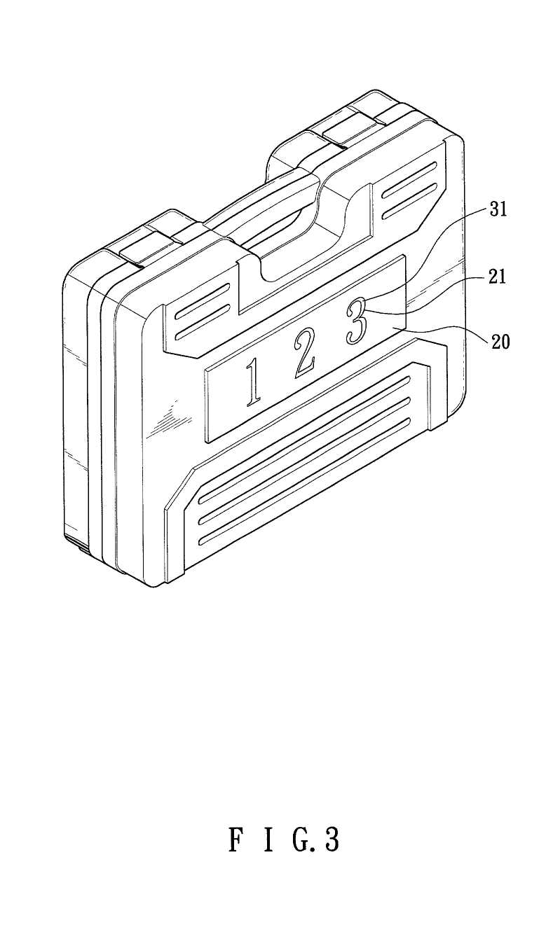

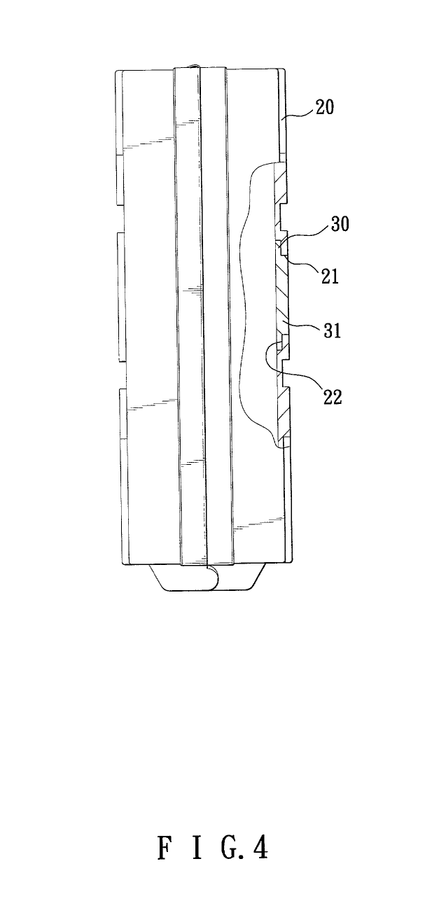

Referring to FIGS. 2 to 4, the tool box of the present invention comprises a first part 200 which is the base and a second part 20 which is a cover pivotally connected to the first part 200. A plurality of apertures 21 are defined through the second part 20 and the apertures 21 are shaped to be desired patterns. A recessed area 22 as shown in FIG. 4 is defined in an inside of the second part 20 and communicates with the apertures 21. The peripheries defining the apertures 21 become a shoulder or step portion.

A decoration plate 30 is engaged with an inside of the second part 20 and a plurality of protrusions 31 extend from the decoration plate 30. The decoration plate 30 is engaged with the recessed area 22 and the protrusions 31 are engaged with the apertures 21 and can be visible from outside of the second part 20. The decoration plate 30 contacts the shoulder or step portion so that it is positioned. The way to secure the decoration plate 30 to the second part 20 can be a snap-fit or other known methods which are familiar to the person in the art. The decoration plate 30 can be easily made to have desired color and patterns, and the decoration plate 30 is conveniently replaced.

While we have shown and described the embodiment in accordance with the present invention, it should be clear to those skilled in the art that further embodiments may be made without departing from the scope of the present invention.

What is claimed is:

1. A box comprising:
a first part and a second part pivotally connected to said first part, a plurality of apertures defined through said second part, and
a decoration plate engaged with an inside of said second part and a plurality of protrusions extending from said decoration plate, said protrusions engaged with said apertures.

2. The box as claimed in claim 1 wherein a recessed area is defined in an inside of said second part and communicating with the apertures, said decoration plate engaged with said decoration plate.
